(19) United States
(12) Patent Application Publication
(10) Pub. No.: US 2005/0174551 A1
(43) Pub. Date: Aug. 11, 2005

(54) Position control and heat dissipation for photolithography systems

(75) Inventor: Alton Hugh Phillips, E. Palo Alto, CA (US)

Correspondence Address: BEYER WEAVER & THOMAS LLP, P.O. BOX 70250, OAKLAND, CA, 94612-0250, US

(73) Assignee: Nikon Corporation, Tokyo (JP)

(21) Appl. No.: 10/777,515

(22) Filed: Feb. 11, 2004

(51) Int. Cl. G03B 27/42

(52) U.S. Cl. 355/53; 355/72; 355/75; 318/649; 310/10; 310/12; 378/34

(57) ABSTRACT

A photolithography system that uses a variable reluctance linear motor (VRLM) to move a reticle or wafer stage is described. In addition to moving the stage, one or more of the surfaces of the VRLM is formed on the reticle or wafer stage and serves as a heat dissipation surface. The surface(s) of the VRLM is in thermal communication with one or more heat generating devices within the stage so that the surface can collect and dissipate heat out of the stage. The VRLM can be used in combination with other types of motors such as Lorentz force linear motors.

### CROSS-REFERENCE TO RELATED APPLICATIONS

This application is related to U.S. patent application Ser. No. 10/734,396 (Attorney Docket No. NIKOP062), filed on Dec. 12, 2003, and entitled “Utilities Transfer System in a Lithography System,” the content of which is hereby incorporated by reference.

### FIELD OF THE INVENTION

The present invention relates generally to photolithography systems, and more specifically to reticle and wafer stage motors.

### BACKGROUND OF THE INVENTION

Photolithography systems are used to manufacture semiconductor devices by exposing semiconductor wafers to specific patterns of light. This is typically done by shining light onto a wafer through a patterned reticle. Each of the reticle and wafer are supported by respective stages that move beneath a light source. Each of the stages is typically supported by substantially friction-free bearings, such as air or electromagnetic bearings. During a scanning process, the stages are individually accelerated to desired velocities so that they can coast upon the bearings. Mechanical actuators and/or electromagnetic devices can be used to provide the relatively large forces needed to accelerate each of the stages.

Typically, the reticle and wafer stages are accelerated so that the reticle stage moves in the same direction with the wafer stage. Then a pattern of light is scanned over the wafer as the reticle and wafer pass under the light source. Since the reticle is typically larger than the wafer, the reticle stage usually moves at a higher speed than the wafer stage so that the entire pattern of the reticle can be exposed onto the wafer. Generally, larger acceleration forces and therefore larger coasting velocities are desirable so that wafers can be exposed to reticle patterns in shorter amounts of time. In other words, higher system throughputs are desirable.

After each of the reticle and wafer stages reaches a desired velocity, each stage ideally would coast at a constant speed underneath the light source. However, the stages typically are unable to maintain sufficiently constant velocities due to various types of vibrations and drag forces. For example, the velocity of wafer stages can diminish due to drag forces imposed by cables that are connected to such stages. Such cables can be necessary to transfer utilities such as electricity, gas, fluids, etc. for operation of wafer stages. Actuators or motors are used to adjust the reticle stage velocity in order to maintain the correct velocity and positional relationship with the wafer stage.

Various types of motors and combinations of motors are used to accelerate and then adjust the velocity of reticle and wafer stages. For instance, variable reluctance linear motors (VRLM's), a type of electromagnetic step motor, can be used. Unfortunately, the inherent nature of VRLM's causes cogging effects during acceleration and velocity adjustments that make it difficult for a stage to achieve smooth constant velocity. Other photolithography systems utilize Lorentz force linear motors (LFLM's), which are based upon Lorentz forces. The problem with LFLM's is that the wire coil assembly generates a large amount of heat that could adversely affect the reticle and the reticle stage. Also, the large mass of the magnet assembly can adversely weigh down a wafer or reticle stage.

In other photolithography systems, a combination of different motor types can be used to accelerate and then adjust the velocity of the stages, respectively. One combination uses a LFLM for acceleration and a Maxwell force linear motor for velocity adjustment. A Maxwell force linear motor, at a very basic level, utilizes a solenoid that exerts an electromagnetic force over a ferrous plate. Another combination uses pneumatic pistons for acceleration and LFLM's for velocity adjustments. Yet another combination uses ball and screw actuators for acceleration and LFLM's for velocity adjustments. Unfortunately, each of these motor types has certain drawbacks. For example, pneumatic pistons are generally noisy and cause large amounts of vibration that affect the acceleration and velocity of the stages. Also, physical contact between moving components, such as within ball and screw actuators, cause wear and tear of such components. Such wear and tear also can generate particles that can contaminate photolithography systems.

As described above, heat generation by stage motors can adversely affect photolithography systems. In more specific terms, heat can be problematic in that it causes deformation of stage structures and components through thermal expansion. Such deformation can cause errors in position control measurements. For example, the air density along the light path of laser interferometers may be disturbed. Unfortunately, motors are not the only source of heat within reticle and/or wafer stages. For example, other devices such as actuators, integrated circuit chips, and the like can also generate heat that can adversely affect a photolithography system. For proper operation of such systems, heat dissipation techniques are necessary to minimize the harmful effects of heat. As with most semiconductor manufacturing technologies, improvements in heat dissipation techniques within photolithography systems are constantly sought after.

In view of the foregoing, there are continuing efforts to provide improved photolithography systems having effective motors for propelling the reticle and/or wafer stages and having effective heat dissipation mechanisms.

### BRIEF SUMMARY OF THE INVENTION

The present invention pertains to a photolithography system that uses a variable reluctance linear motor (VRLM) to move a reticle or wafer stage. In addition to moving the stage, one or more of the surfaces of the VRLM is formed on the reticle or wafer stage and serves as a heat dissipation surface. The surface(s) of the VRLM is in thermal communication with one or more heat generating devices within the stage so that the surface can collect and dissipate heat out of the stage. This prevents heat from adversely affecting the stage structure and/or various components within the stage. The VRLM can be used in combination with other types of motors such as Lorentz force linear motors.

One aspect of the present invention pertains to a photolithography system that includes a stage suitable for supporting a patterned reticle or a semiconductor wafer, a stage rib panel attached to a surface of the stage, the stage rib panel being magnetizable and having parallel rows of ribs that are each separated by a recessed channel, the stage rib panel suitable for collecting heat generated from within the stage, a frame having an internal slot wherein the stage is contained within the slot, and a frame rib panel attached to a surface of the frame such that the stage rib panel and the frame rib panel face each other, the frame rib panel being magnetizable and having parallel rows of ribs that are each separated by a recessed channel, wherein one or more magnetic fields are sequentially generated within the frame rib panel in order to impose electromagnetic forces upon the stage rib panel to move the stage with respect to the frame. In one embodiment of the photolithography system, a filler material fills in each of the recessed channels of the stage rib panel such that the stage rib panel has a substantially flat surface formed of the filler material and a top surface of each of the ribs, whereby the flat surface facilitates heat dissipation out of the stage rib panel and the stage.

Another embodiment of the photolithography system of the present invention includes a stage suitable for supporting a patterned reticle or a semiconductor wafer, a frame having an internal slot wherein the stage is contained within the slot, a variable reluctance electromagnetic motor and a Lorentz force electromagnetic motor. The variable reluctance electromagnetic motor includes at least two stage rib panels attached to each of the top and bottom surfaces of the stage, the stage rib panels being magnetizable and having parallel rows of ribs that are each separated by a recessed channel, the stage rib panels suitable for collecting heat generated from within the stage, at least two frame rib panels attached to each of the ceiling and floor surfaces of the frame such that each stage rib panel faces an opposing frame rib panel, the frame rib panels being magnetizable and having parallel rows of ribs that are each separated by a recessed channel, wherein one or more magnetic fields are sequentially generated within the frame rib panel in order to impose electromagnetic forces upon the stage rib panel to accelerate the stage to a desire velocity with respect to the frame along a scanning axis. The Lorentz force electromagnetic motor includes a row of opposing magnet pairs within the stage wherein each magnet of each magnet pair has an opposite magnetic polarity and wherein a magnetic field is created between each opposing magnet pair, and a lengthwise coil assembly within the slot of the frame that extends through the stage and between the row of opposing magnets, the coil assembly having a plurality of wire coils, wherein a current within each wire coil and each of the magnetic fields generates an electromagnetic force suitable for adjusting the velocity of the stage.

Another embodiment of the photolithography system of the present invention includes an illumination source, an optical system, a reticle stage suitable for supporting a patterned reticle, a working stage arranged to retain a workpiece, an enclosure that surrounds at least a portion of the working stage, the enclosure having a sealing surface, a stage rib panel attached to a surface of the stage, the stage rib panel being magnetizable and having parallel rows of ribs that are each separated by a recessed channel, the stage rib panel suitable for collecting heat generated from within the stage, a frame having an internal slot wherein the stage is contained within the slot, and a frame rib panel attached to a surface of the frame such that the stage rib panel and the frame rib panel face each other, the frame rib panel being magnetizable and having parallel rows of ribs that are each separated by a recessed channel, wherein one or more magnetic fields are sequentially generated within the frame rib panel in order to impose electromagnetic forces upon the stage rib panel to move the stage with respect to the frame.

These and other features and advantages of the present invention will be presented in more detail in the following specification of the invention and the accompanying figures, which illustrate by way of example the principles of the invention.

### BRIEF DESCRIPTION OF THE DRAWINGS

The invention, together with further advantages thereof, may best be understood by reference to the following description taken in conjunction with the accompanying drawings in which:

FIG. 1 illustrates a diagrammatic overview of the common components of a photolithography system.

FIG. 2 illustrates a perspective, cross-sectional view of a reticle stage and its supporting frame according to one embodiment of the present invention.

FIG. 3 illustrates a side, cross-sectional view of the stage of FIG. 2 along line 3-3.

FIG. 4 illustrates an enlarged and fragmentary view of the stage of FIG. 3 along line 4-4.

FIG. 5 illustrates a top cross-sectional view of the stage of FIG. 3 that shows the position of the magnets within the stage.

FIG. 6 illustrates an exemplary process for fabricating semiconductor devices using the systems described above.

FIG. 7 illustrates a detailed flowchart example of the above-mentioned step of the process of FIG. 6.

### DETAILED DESCRIPTION OF THE INVENTION

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known operations have not been described in detail so not to unnecessarily obscure the present invention.

The present invention pertains to a photolithography system that uses a variable reluctance linear motor (VRLM) to move a reticle or wafer stage. In addition to moving the stage, one or more of the surfaces of the VRLM is formed on the reticle or wafer stage and serves as a heat dissipation surface. The surface(s) of the VRLM is in thermal communication with one or more heat generating devices within the stage so that the surface can collect and dissipate heat out of the stage. This prevents heat from adversely affecting the stage structure and/or various components within the stage. The VRLM can be used in combination with other types of motors such as Lorentz force linear motors. Such combination of motors can effectively take advantage of certain aspects of each motor type.

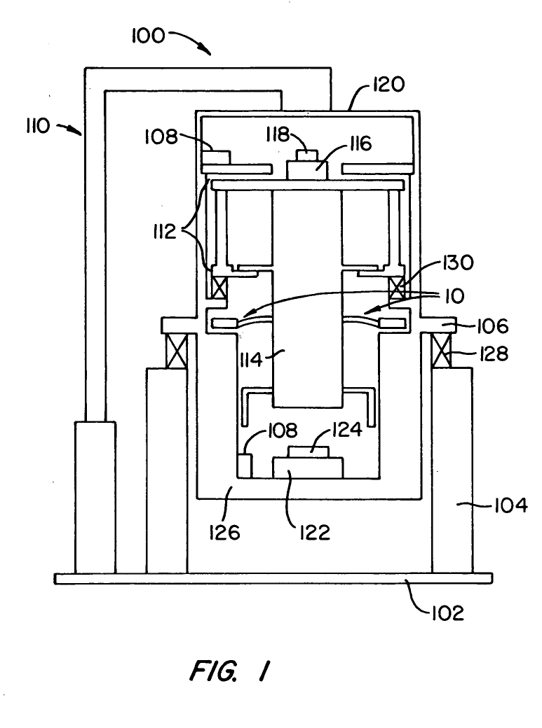

FIG. 1 illustrates a diagrammatic overview of the common components of a photolithography system 100. The following section describes these components; however note that the pertinent components of system 100 relative to the present invention are reticle stage 116, optical frame 112, wafer stage 122, and lower enclosure 126. Reticle stage 116, which supports reticle 118, is supported by and moves in controlled motions with respect to optical frame 112. As reticle stage 116 moves, light from above or below reticle 118 can be used to illuminate a specific pattern upon selected areas of wafer 124. Wafer stage 122, which supports wafer 124, is supported by and moves in controlled motions with respect to lower enclosure 126. Note that although reticle stage 116 is positioned above optical frame 112, other photolithography systems position the reticle stage within a supporting frame.

Photolithography system 100 includes a mounting base 102, a support frame 104, a base frame 106, a measurement system 108, a control system (not shown), an illumination system 110, an optical frame 112, an optical device 114, a reticle stage 116 for retaining a reticle 118, an upper enclosure 120 surrounding reticle stage 116, a wafer stage 122 for retaining a semiconductor wafer 124, and a lower enclosure 126 surrounding wafer stage 122.

Support frame 104 typically supports base frame 106 above mounting base 102 through a base vibration isolation system 128. Base frame 106 in turn supports, through an optical vibration isolation system 130, optical frame 112, measurement system 108, reticle stage 116, upper enclosure 120, optical device 114, wafer stage 122, and lower enclosure 126 above base frame 106. Optical frame 112 in turn supports optical device 114, reticle stage 116, and reticle 118 above base frame 106 through optical vibration isolation system 130. As a result thereof, optical frame 112 and its supported components and base frame 106 are effectively attached in series through base vibration isolation system 128 and optical vibration isolation system 130 to mounting base 102. Vibration isolation systems 128 and 130 are designed to damp and isolate vibrations between components of photolithography system 100. Any of the previously describe seals 132 are placed between base frame 106 (the upper enclosure 120) and the lens assembly 114. The described sealing arrangement provides a good seal for the enclosure 120, yet helps prevent the transmission of vibrations between the enclosure and the lens assembly 114. Measurement system 108 monitors the positions of stages 116 and 122 relative to a reference such as optical device 114 and outputs position data to the control system.

Optical device 114 typically includes a lens assembly that projects and/or focuses the light or beam from an illumination system 110 that passes through reticle 118. In other embodiments of apparatus 100, illumination system 110 and optical device 114 is set up to project and/or focus light such that it reflects off of reticle 118.

Reticle stage 116 is set upon optical frame 112 so that reticle stage 116 can move through controlled movements (e.g., scanning motions) with respect to optical frame 112 and wafer 124. Reticle stage 116 can be set upon guides that help guide the movement of reticle stage 116. Or, reticle stage 116 could be a guideless type stage that uses no guides. Exemplary guides include air bearings, ball bearings, electromagnetic bearings (Lorentz force, Maxwell force), or permanent magnets. Reticle stage 116 can be moved in the desired motions by movers. Movers can be various types of actuators such as piezoelectric actuators, electromagnetic actuators (Lorentz force, Maxwell force), pneumatic actuators, and ball and screw actuators among others.

Similarly, wafer stage 122 can be set upon lower enclosure 126 and guided through controlled movements with or without guides as described for reticle stage 116. Also wafer stage 122 can be moved with similar movers as described for reticle stage 116.

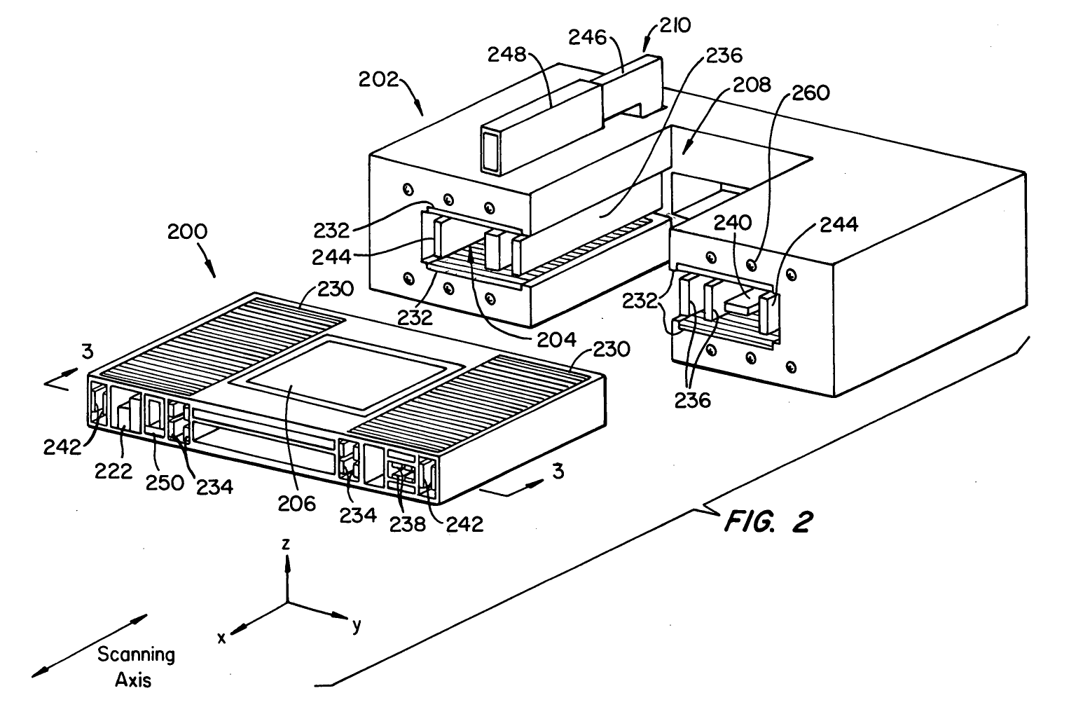

When magnetic levitation is used, reticle stage 116 can be driven by an electromagnetic planar motor. Such a motor can have a magnet unit with two-dimensionally arranged magnets and an armature coil unit having two-dimensionally arranged coils in facing positions. With this type of driving system, either one of the magnet unit or the armature coil unit is connected to the stage and the other unit is mounted on the optical frame. For example in FIG. 2, Lorentz motors can provide magnetic forces upon stage 200 for either levitation or velocity control purposes. These Lorentz motors are formed of mating magnet and armature coil structures 234 and 236, 238 and 240, and 242 and 244, respectively.

Movement of reticle stage 116 and wafer stage 122 as described above generates reaction forces, which can affect performance of the photolithography system. Reaction forces generated by wafer (substrate) stage 122 motion can be mechanically released to the floor (ground) by use of a frame member as described in U.S. Pat. No. 5,528,118 and published Japanese Patent Application Disclosure No. 8-166475. Additionally, reaction forces generated by reticle (mask) stage 116 motion can be mechanically released to the floor (ground) by use of a frame member as described in U.S. Pat. No. 5,874,820 and published Japanese Patent Application Disclosure No. 8-330224. In other systems, reaction forces generated by a wafer stage or a reticle stage can also be released to the frame. The disclosures in U.S. Pat. Nos. 5,528,118 and 5,874,820 and Japanese Patent Application Disclosure No. 8-330224 are incorporated herein by reference.

As will be appreciated by those skilled in the art, there are a number of different types of photolithographic devices. For example, photolithography system 100 can be used as a scanning type photolithography system, which exposes the pattern from reticle 118 onto wafer 124 with reticle 118 and wafer 124 moving synchronously. In a scanning type lithographic device, reticle 118 is moved perpendicular to an optical axis of lens assembly 114 by reticle stage 116 and wafer 124 is moved perpendicular to an optical axis of lens assembly 114 by wafer stage 122. Scanning of reticle 118 and wafer 124 occurs while reticle 118 and wafer 124 are moving synchronously.

Alternately, photolithography system 100 can be a step-and-repeat type photolithography system that exposes reticle 118 while reticle 118 and wafer 124 are stationary. In the step and repeat process, wafer 124 is in a constant position relative to reticle 118 and lens assembly 114 during the exposure of an individual field. Subsequently, between consecutive exposure steps, wafer 124 is consecutively moved by wafer stage 122 perpendicular to the optical axis of lens assembly 114 so that the next field of semiconductor wafer 124 is brought into position relative to lens assembly 114 and reticle 118 for exposure, Following this process, the images on reticle 118 are sequentially exposed onto the fields of wafer 124 so that the next field of semiconductor wafer 124 is brought into position relative to lens assembly 114 and reticle 118.

However, the use of photolithography system 100 provided herein is not limited to a photolithography system for a semiconductor manufacturing. Photolithography system 100, for example, can be used as an LCD photolithography system that exposes a liquid crystal display device pattern onto a rectangular glass plate or a photolithography system for manufacturing a thin film magnetic head. Further, the present invention can also be applied to a proximity photolithography system that exposes a mask pattern by closely locating a mask and a substrate without the use of a lens assembly. Additionally, the present invention provided herein can be used in other devices, including other semiconductor processing equipment, machine tools, metal cutting machines, and inspection machines.

The illumination source (of illumination system 110) can be g-line (436 nm), i-line (365 nm), KrF excimer laser (248 nm), ArF excimer laser (193 nm) and F₂ laser (157 nm). Alternatively, the illumination source can also use charged particle beams such as x-ray and electron beam. For instance, in the case where an electron beam is used, thermionic emission type lanthanum hexaboride (LaB₆,) or tantalum (Ta) can be used as an electron gun. Furthermore, in the case where an electron beam is used, the structure could be such that either a mask is used or a pattern can be directly formed on a substrate without the use of a mask.

With respect to lens assembly 114, when far ultra-violet rays such as the excimer laser are used, glass materials such as quartz and fluorite that transmit far ultra-violet rays is preferably used. When the F₂ type laser or x-ray is used, lens assembly 114 should preferably be either catadioptric or refractive (a reticle should also preferably be a reflective type), and when an electron beam is used, electron optics should preferably comprise electron lenses and deflectors. The optical path for the electron beams should be in a vacuum.

Also, with an exposure device that employs vacuum ultra-violet radiation (VUV) of wavelength 200 nm or lower, use of the catadioptric type optical system can be considered. Examples of the catadioptric type of optical system include the disclosure Japan Patent Application Disclosure No. 8-171054 published in the Official Gazette for Laid-Open Patent Applications and its counterpart U.S. Pat. No. 5,668,672, as well as Japan Patent Application Disclosure No. 10-20195 and its counterpart U.S. Pat. No. 5,835,275. In these cases, the reflecting optical device can be a catadioptric optical system incorporating a beam splitter and concave mirror. Japan Patent Application Disclosure No. 8-334695 published in the Official Gazette for Laid-Open Patent Applications and its counterpart U.S. Pat. No. 5,689,377 as well as Japan Patent Application Disclosure No. 10-3039 also use a reflecting-refracting type of optical system incorporating a concave mirror, etc., but without a beam splitter, and can also be employed with this invention. The disclosures in the above mentioned U.S. patents, as well as the Japan patent applications published in the Official Gazette for Laid-Open Patent Applications are incorporated herein by reference.

The present invention can also be implemented when photolithography system 100 is an extreme ultraviolet photolithography (EUVL) system. In EUVL systems, illumination source 110 generates light at extremely small wavelengths. For example, light of wavelengths in the range of approximately 13 nm that is produced by laser produced plasma (LPP) or gas discharged plasma (GDP) can be used. Optical components of EUVL systems typically use reflective optics with special multilayer coatings of silicon and molybdenum since refractive optics absorb an excessive amount of the EUV radiation. Also, since most gases absorb EUV radiation, the EUV beam path is typically contained within a vacuum environment.

As described above, a photolithography system according to the above-described embodiments can be built by assembling various subsystems, including each element listed in the appended claims, in such a manner that prescribed mechanical accuracy, electrical accuracy, and optical accuracy are maintained. In order to maintain the various accuracies, prior to and following assembly, every optical system is adjusted to achieve its optical accuracy. Similarly, every mechanical system and every electrical system are adjusted to achieve their respective mechanical and electrical accuracies. The process of assembling each subsystem into a photolithography system includes mechanical interfaces, electrical circuit wiring connections and air pressure plumbing connections between each subsystem. Needless to say, there is also a process where each subsystem is assembled prior to assembling a photolithography system from the various subsystems. Once a photolithography system is assembled using the various subsystems, total adjustment is performed to make sure that every accuracy is maintained in the complete photolithography system. Additionally, it is desirable to manufacture an exposure system in a clean room where the temperature and humidity are controlled.

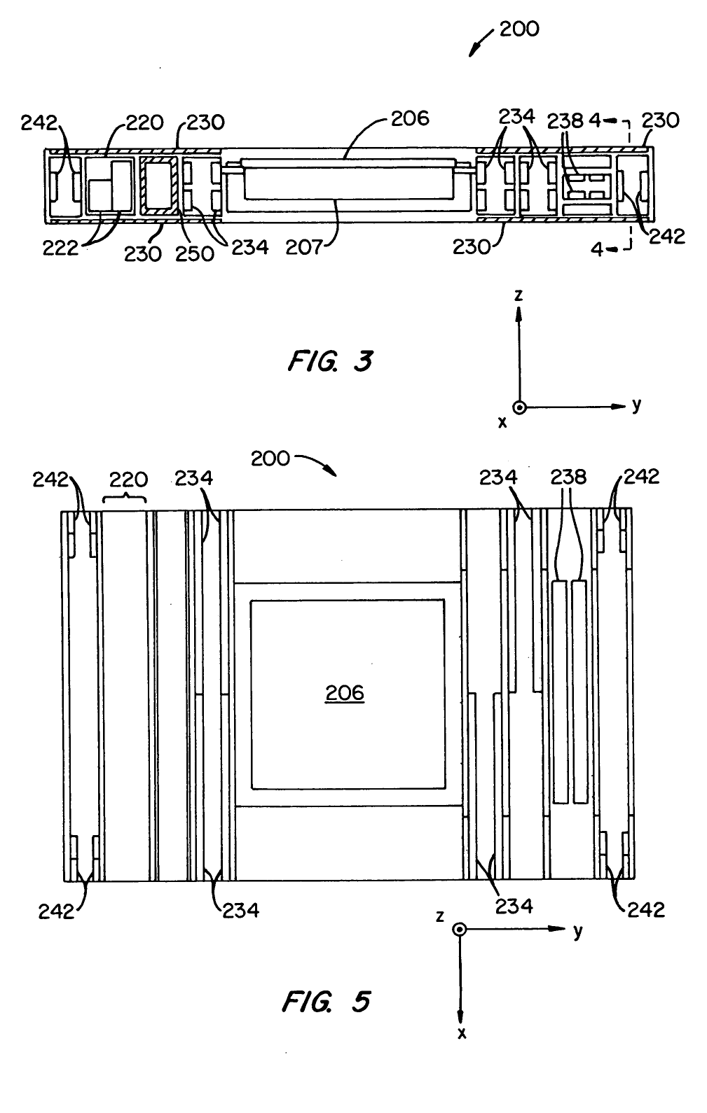

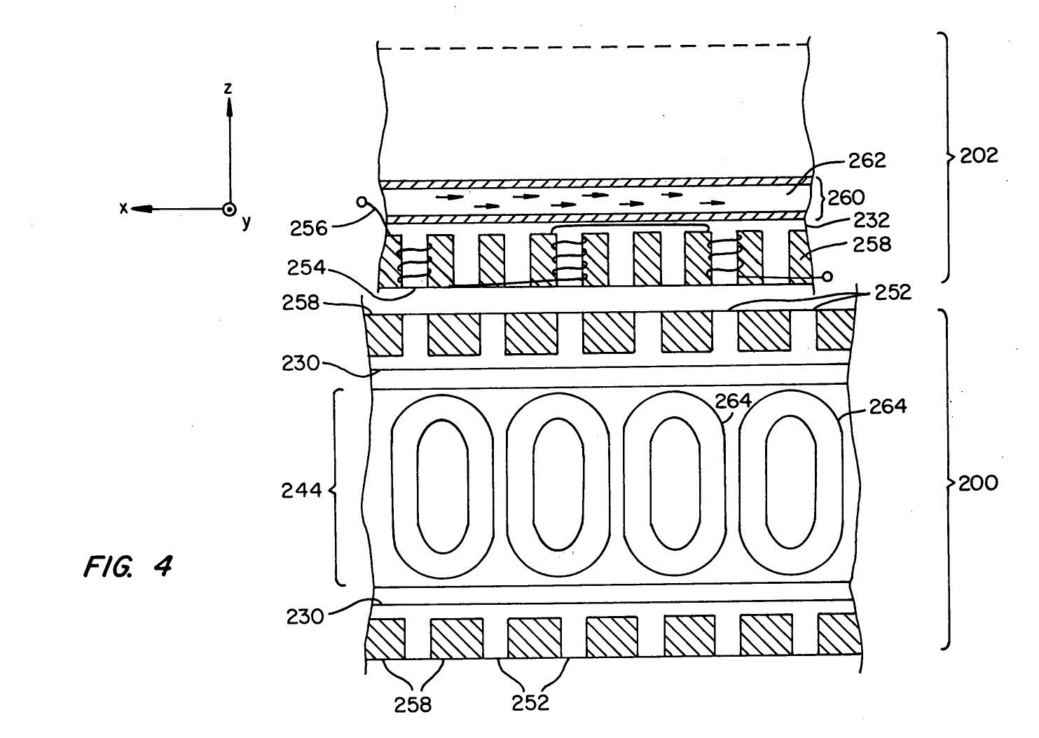

Now that the common components of a photolithography system have been described, FIGS. 2-5 will focus upon one embodiment of a variable reluctance linear motor (VRLM) that is used to move a reticle stage with an optical frame. FIG. 2 illustrates a perspective, cross-sectional view of a reticle stage 200 and its supporting frame 202 according to one embodiment of the present invention. The cross-section of frame 202 of FIG. 2 is taken approximately at a mid-point such that one-half of frame 202 is shown. The cross-section of stage 200 is taken near one end of stage 200. FIG. 3 illustrates a side, cross-sectional view of stage 200 of FIG. 2 along line 3-3. FIG. 4 illustrates an enlarged and fragmentary view of stage 200 along line 4-4 of FIG. 3. FIG. 5 illustrates a top cross-sectional view of stage 200 that shows the position of magnets 234, 238, and 242 within stage 200.

In assembled form, stage 200 would freely slide within slot 204 and be completely enclosed by frame 202. Techniques using electromagnets or air pressure can be used to suspend stage 200 within slot 204 so that stage 200 can move freely within slot 204 such that physical contact between stage 200 and slot 204 is avoided. One embodiment of a photolithography system as shown in FIG. 2 is designed so that stage 200 has a long stroke motion along the x-axis that covers approximately 300 nm, a shorter stroke motion along the y-axis that covers approximately a few mm, and a short stroke motion along the z-axis that covers approximately 0.1 mm or less. It should be understood that the techniques described below relating to dissipation of heat from stage 200 and to controlling the velocity and position of stage 200 are substantially applicable for dissipating heat from wafer stage 122 and for controlling the velocity and position of wafer stage 122.

Stage 200 supports a reticle 206, which is accessible to a light source through opening 208 of frame 202. Each of stage 200 and frame 202 contain portions of various systems that assist in the functions of stage 200. The portions of each system within each of stage 200 and frame 202 work together to provide various functions such as heat dissipation for stage 200, forces for moving and controlling the movement of stage 200, forces for suspending stage 200 within slot 204, and electrical power for stage 200. One of these systems is a variable reluctance linear motor (VRLM) that can provide stage 200 with heat dissipation capabilities, and propulsion forces to move and suspend stage 200 within slot 204. The VRLM generally includes four stage rib panels 230 and four corresponding frame rib panels 232.

Another set of systems includes Lorentz force motors that can provide propulsion forces to move and suspend stage 200 within slot 204. The Lorentz force motors generally include magnets or electromagnets that are located within stage 200 and coil assemblies that are located within slot 204. The Lorentz force motors are arranged so that a motor provides forces in each of the degrees of freedom within which stage 200 can move. Specifically, magnets 234 and coil assemblies 236 work together to provide forces upon stage 200 along the z-axis, which is in the vertical directions. Note that when stage 200 is placed within slot 204, coil assemblies 236 insert into the slot within stage 200 and between magnets 234. Magnets 238 and coil assembly 240 work together to provide forces upon stage 200 along the y-axis, which is in the direction that is perpendicular to the scanning axis. Magnets 242 and coil assembly 244 work together to provide forces upon stage 200 along the x-axis, which is along the scanning axis.

As can be seen in FIG. 5, magnets 234, 238, and 242 are positioned about stage 200 such that they can also impose rotational forces about each of the x, y, and z-axes. For instance, magnets 242 can impose a rotational force, T_{z}, upon stage 200 about the z-axis since magnets 242 are positioned about each corner of stage 200 and because they impose forces along the x-axis. Magnets 234 can impose rotational forces, Tx and/or Ty, upon stage 200 about the x and y-axes, respectively, since they impose forces along the z-axis. In FIG. 5 only, each of magnets 234 are separately indicated as one of 234a, 234b, or 234c. Magnets 234a span the entire length of stage 200. Magnets 234b span one-half of stage 200 along the x-axis while magnets 234c span the opposite half of stage 200. Opposing forces by magnets 234b and 234c can impose rotational force Ty. Or a force by only one of magnets 234b or 234c can impose rotational force T_{y}. Opposing forces between magnets 234a and 234b and/or 234c can impose rotational force Tₓ. Or a force by only one of magnets 234a, 234b, or 234c can impose rotational force Tₓ.

And yet another system is a transformer 210 that provides electrical power to stage 200. Transformer 210 includes a conductive core 246, a primary coil 248 that is wrapped around one end of core 246, and a secondary coil 250, which is located within stage 200. Again, note that when stage 200 is placed within slot 204, inductive core 246 inserts into secondary coil 250. Stage 200 also includes electronics compartment 220 that provides room for buffer devices, processing devices, sensors, and other types of devices.

As described above, the VRLM has four stage rib panels 230 and four frame rib panels 232. As seen in FIG. 3, two of the stage rib panels 230 are on the top surface of stage 200 and the other two stage rib panels 230 are on the bottom surface of stage 200. As seen in FIG. 2, two frame rib panels 232 are positioned on the top surface (ceiling) of slot 204 and two frame rib panels 232 are positioned on the bottom surface (floor) of slot 204. When stage 200 is positioned within slot 204, each stage rib panel 230 matches up to a respective frame rib panel 232. As seen in FIG. 2, each stage and frame rib panel 230 and 232 has a flat panel shape with parallel rows of ribs on the exposed surface of each panel. FIG. 3 is a cross-sectional view of a portion of stage 200 of FIG. 3 along line 3-3. FIG. 4 more clearly shows each of the ribs 252 of stage rib panels 230 and the ribs 254 of frame rib panel 232. In some embodiments, the spacing between each of ribs 252 of stage 200 is larger than the spacing between each of ribs 254 of frame rib panel 232.

As is typical with variable reluctance linear motors, separate wire windings are wound around individual ribs 254. Each wire winding winds around selected ribs that are equally spaced apart from each other. FIG. 4 illustrates one of the wire windings 256 which winds around every fourth rib 254. Electrical current through wire winding 256 causes each successive rib 254, around which is wound the wire of wire winding 256, to have opposing magnetic poles. Magnetized ribs 254 pull on each rib 252 of stage 200. When a rib 254 of frame 202 is aligned with a rib 252 of stage 200, the pull between the ribs is normal to the respective rib surfaces. When a rib 254 and a rib 252 are slightly offset, the pull between the ribs is at an angle to the surface of each rib. When force vectors from upper and lower ribbed actuators (upper and lower surfaces of stage 200) are added together, the net z-component of the force vector is zero and the net x-component of the force vector is non-zero. The net force applied to stage 200 along the x-axis allows the velocity and position of stage 200 can be controlled.

The two additional wire windings that wind around the other ribs are not shown to more clearly illustrate wire winding 256. It should be understood that the two wire windings that are not shown would wind around equally spaced ribs 254 in a similar manner to that of wire winding 256. By synchronizing the flow of current through each of the wire windings, a force can be applied to stage 200 for velocity and position control.

VRLM motors can be at least one of the techniques for supporting stage 200 within slot 204 so that stage 200 and frame 202 do not come into physical contact. The electromagnetic forces generated by the VRLM motors can be used to levitate stage 200 within slot 204. In this way, stage 200 can move within slot 204 and along the scanning axis substantially without a drag force introduced by friction. The magnetic forces of VRLM should be centered and balanced around the center of mass of stage 200 so that stage 200 can be evenly supported. Balance about the center of mass is also important so that a disproportionately large magnetic force does not draw stage 200 into contact with the ceiling or floor of slot 204. One way to facilitate equal magnetic forces about stage 200 is to use stage and frame rib panels 230 and 232 that are symmetrical about the center of mass of stage 200.

In some embodiments of stage 200 and frame 202, multiple sets of stage and frame rib panels 230 and 232 can be used. This can aid in controlling the pitch of the stage with respect to the scanning axis. Multiple stage rib panels that are each smaller than a single large stage rib panel 230 are advantageous in that less thermal expansion stress is imposed upon the stage structure.

In alternative embodiments, stage and frame rib panels 230 and 232 can have studs that are arranged in rows and columns so that forces for propulsion and position control for stage 200 can be applied along the scanning axis and along a relatively orthogonal direction. Conceptually, this is substantially equivalent to having two sets of ribs that extend in orthogonal directions with respect to each other.

As discussed above, the VRLM's also provide stage 200 with heat dissipation abilities. The surface area of each of stage rib panels 230 provides a large surface area for heat dissipation. Typically, stage and frame rib panels 230 and 232 are formed of magnetizable material such as a ferrous material. Such panels also tend to conduct heat well and thereby serve as heat sinks and surfaces for heat to dissipate out of stage 200. Heat can be generated within stage 200 by various components such as reticle 206, various electrical devices 222, coil assemblies 236, 240, and 244, and secondary inductive coil 250. Heat can be transmitted for collection in stage rib panels 230 through conductive, convective, and/or radiative techniques. For example, heat-generating devices can be placed adjacent to or in contact with one or more of stage rib panels 230. Also, heat transfer paths, which can be formed of thermally conductive materials or constitute heat pipes, can thermally connect heat-generating devices to stage rib panels 230. By effectively transferring heat to stage rib panels 230, heat can then be dissipated out of stage 200.

As described above, heat that dissipates out of stage rib panels 230 can be collected by frame rib panels 232. Frame rib panels 232 can be maintained at a relatively low temperature with respect to stage rib panels 230 to increase the ability of frame rib panels 232 to remove heat from stage rib panels 230. Various techniques can be used to maintain a low temperature for frame rib panels 232. A technique illustrated in FIGS. 2 and 4 involves the use of multiple fluid channels 260 that run near or adjacent to frame rib panels 232. Fluid 262 is circulated through fluid channels 260 in order to collect and remove heat energy from each of frame rib panels 232. Maintaining fluid 262 at a relatively low temperature allows fluid channels 260 to effectively cool frame rib panels 232.

As seen in FIG. 4, a filler material 258 is formed within each of the recesses that are formed between ribs 252 of stage rib panel 230 and ribs 254 of frame rib panel 232. Filler material 258 is formed so that the top surfaces of ribs 252 and 254 and that of filler material 258 give the exposed surfaces of stage rib panels 230 and frame rib panels 232 a substantially flat surface. The flat surface of rib panels 230 and 232 increase the ability of the panels to transmit and receive heat energy. Filler material 258 should be non-ferrous so that the electromagnetic interaction between stage and frame rib panels 230 and 232 is not affected. Note that filler material 258 is an optional aspect for each of stage and frame rib panels 230 and 232. In some embodiments, filler material 258 could be used in one, both, or none of stage and frame rib panels 230 and 232.

It should be understood that the techniques of the present invention could be implemented in stages and frames having different configurations and methods of use. For example, stage 200 can support a reticle 206 that is meant to transmit light or reflect light onto a semiconductor wafer. The embodiment shown in FIGS. 2 and 3 is suitable for light to reflect off of reticle 206 where reticle 206 is supported with a separate support structure referred to as a chuck 207. Such a chuck 207, as shown in FIG. 3, can be independently oriented with respect to stage 200 through the use of actuators, drivers, sensors, etc.

FIG. 4 shows the individual coils of wire 264 within coil assembly 244 of one of the Lorentz motors. The electrical current that flows through each of coils 264, and through the coils of coil assemblies 236 and 240 generate heat. Since the coil assemblies are positioned within stage 200 during normal operation, heat from the coil assemblies can adversely affect operation of stage 200. Cooling channels within each of coil assemblies 236, 240 and 244 can collect and remove heat from each of the coil assemblies.

Stage 200 is shown to use a combination of VRLM motors and Lorentz force motors. The VRLM motors can provide the large forces required to accelerate stage 200 from a stand still to a desired velocity and to decelerate stage 200 back down to a stand still. The Lorentz force motors can be used during the constant velocity portions of the stage's movement to adjust the velocity and position of stage 200 in each of the six degrees of freedom. This combination of motors is advantageous because the Lorentz force motors can smoothly adjust the velocity and position of stage 200. Also, since smaller forces are required from the Lorentz force motors, smaller magnets and coil assemblies are necessary. This advantageous since smaller magnets impose a smaller mass upon stage 200 and smaller coil assemblies generate less heat energy. On the other hand, VRLM's would be less effective at providing fine adjustment of stage 200 position and velocity since VRLM's are subject to “cogging effects” due to the inherent nature of the ribs of each stage and frame rib panels 230 and 232. Such effects might cause unsteady adjustment of a stage's velocity. The VRLM motors are very effective, however, at applying large forces upon stage 200 for acceleration and deceleration purposes. Note that in other embodiments, stage 200 does not include Lorentz motors. In these embodiments, the acceleration/deceleration and control of velocity and position of stage 200 can be controlled solely by VRLM's.

Transformer 210 is used to transfer power through electrical induction between stage 200 and frame 202. Transformer 210 is a non-contact device in that no physical contact is required between transformer components contained within each of stage 200 and frame 202. With non-contact stage levitation and power transmission techniques, power can be supplied to a moving or stationary stage 200 while minimizing physical disturbance forces to stage 200. Transformer 210, as shown in FIGS. 2 and 3, extends into frame 202, within slot 204, and along the outside surface of frame 202. Transformer 210 includes an inductive core 246, an inductive primary coil 248, and an inductive secondary coil 250. Primary coil 248 is wrapped around the portion of inductive core 246 that is outside of stage 200 and frame 202. Secondary coil 250 is housed within stage 200. As is commonly understood, a current through primary coil 248 creates an electromagnetic field that is directed by inductive core 246 so that the electromagnetic field causes current to flow within secondary coil 250. In other words, power is supplied to primary coil 248 so that inductive secondary coil 250 can draw power through inductive core 246. Inductive secondary coil 250 is secured within stage 200 such that the portion of inductive core 246 within slot 204 inserts into inductive secondary coil 250 when stage 200 is inserted into slot 204. The portion of inductive core 246 within slot 204 is positioned so that inductive secondary coil 250 can freely move over inductive core 246 while stage 200 moves along a scanning axis 218 during scanning processes.

The electrical current generated within secondary coil 250 generates heat, which can adversely affect stage 200 and other components within stage 200. Heat from secondary coil 250 can be collected by the adjacent stage rib panels 230 that are positioned above and below secondary coil 250. Heat can be drawn from secondary coil 250 and into stage rib panels 230 in various manners. In some embodiments, heat is transferred to stage rib panels 230 through conduction when secondary coil 250 is in direct contact with the adjacent stage rib panels 230. In other embodiments, non-electrically conductive materials can physically connect and provide a heat pathway between secondary coil 250 and stage rib panels 230. In yet other embodiments, conduits within stage 200 can transfer fluids that transport heat from heat producing components, such as secondary coil 250, to stage rib panels 230.

In alternative embodiments, multiple inductive secondary coils can be arranged to loop over inductive core 246 within stage 200. By having more than one inductive secondary coil, stage 200 can draw power at different voltage levels from each of the inductive secondary coils. In yet other embodiments, multiple transformers can be positioned at various locations of stage 200 and frame 202. Accordingly, stage 200 would have multiple inductive secondary coils to receive an end of the inductive core for each of the transformers. Heat from each of these secondary coils can collected by stage rib panels 230 in a similar manner as described above.

Reticle 206 also collects heat during operation of the photolithography system. Reticle 206 collects heat when light from a light source is directed at reticle 206 in order to illuminate a pattern upon a substrate, such as a semiconductor wafer. Heat from reticle 206 is typically transferred to chuck 207, which supports reticle 206. Heat from reticle 206 and chuck 207 should also be removed from stage 200 before adversely affecting the photolithography system. For example, heat can cause slippage of contact between chuck 207 and reticle 206 due to differences in material thermal expansion coefficients. Thermal communication pathways can be established between the reticle 206 and chuck 207 combination and the stage rib panels 230. For example, thermally conductive materials can connect the reticle 206 and chuck 207 combination and the stage rib panels 230.

Electrical devices 222 also generate heat during operation, which should be removed from stage 200. Such devices 222 can be positioned within stage 200 such that they are in close proximity to stage rib panels 230. In this way, heat from the electrical devices 222 can more easily be transferred to stage rib panels 230.

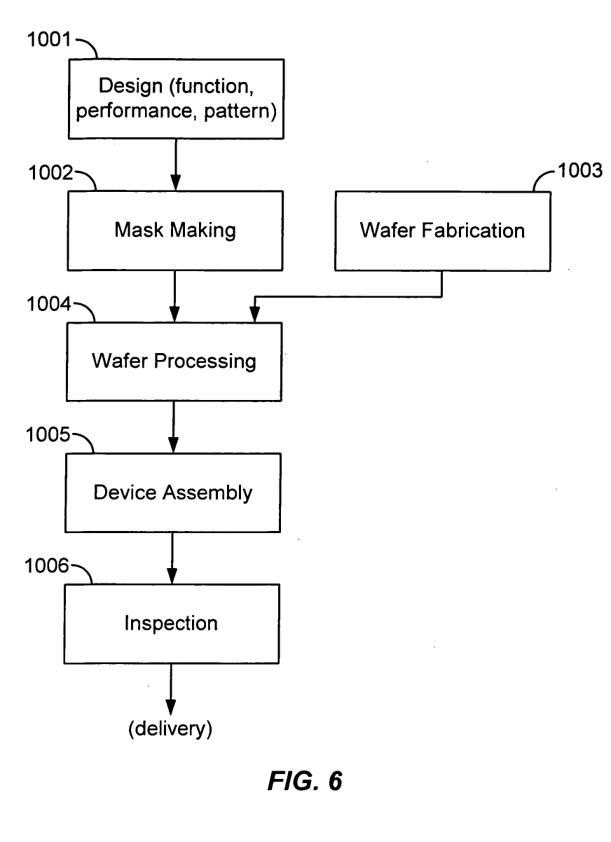

Semiconductor devices can be fabricated using the above-described systems, by the process shown generally in FIG. 6. In step 1001 the device's function and performance characteristics are designed. Next, in step 1002, a mask (reticle) having a pattern it designed according to the previous designing step, and in a parallel step 1003, a wafer is made from a silicon material. The mask pattern designed in step 1002 is exposed onto the wafer from step 1003 in step 1004 by a photolithography system such as the systems described above. In step 1005 the semiconductor device is assembled (including the dicing process, bonding process and packaging process), then finally the device is inspected in step 1006.

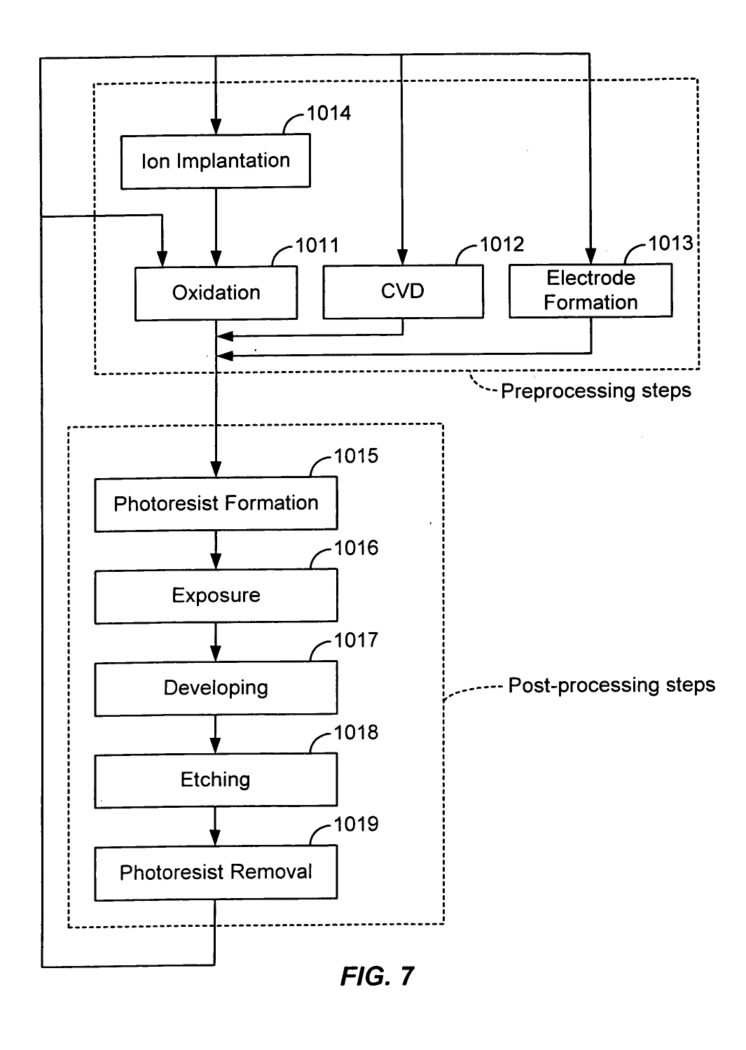

FIG. 7 illustrates a detailed flowchart example of the above-mentioned step 1004 in the case of fabricating semiconductor devices. In step 1011 (oxidation step), the wafer surface is oxidized. In step 1012 (CVD step), an insulation film is formed on the wafer surface. In step 1013 (electrode formation step), electrodes are formed on the wafer by vapor deposition. In step 1014 (ion implantation step), ions are implanted in the wafer. The above-mentioned steps 1011-1014 form the preprocessing steps for wafers during wafer processing, and selection is made at each step according to processing requirements.

At each stage of wafer processing, when the above-mentioned preprocessing steps have been completed, the following post-processing steps are implemented. During post-processing, initially, in step 1015 (photoresist formation step), photoresist is applied to a wafer. Next, in step 1016, (exposure step), the above-mentioned exposure device is used to transfer the circuit pattern of a mask (reticle) to a wafer. Then, in step 1017 (developing step), the exposed wafer is developed, and in step 1018 (etching step), parts other than residual photoresist (exposed material surface) are removed by etching. In step 1019 (photoresist removal step), unnecessary photoresist remaining after etching is removed. Multiple circuit patterns are formed by repetition of these preprocessing and post-processing steps.

While this invention has been described in terms of several preferred embodiments, there are alteration, permutations, and equivalents, which fall within the scope of this invention. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

1. A photolithography system comprising:
a stage suitable for supporting a patterned reticle or a semiconductor wafer;
a stage rib panel attached to a surface of said stage, said stage rib panel being magnetizable and having substantially parallel rows of ribs, said stage rib panel suitable for collecting heat generated from within said stage;
a frame having an internal slot wherein said stage is contained within said slot; and
a frame rib panel attached to a surface of said frame such that said stage rib panel and said frame rib panel face each other, said frame rib panel being magnetizable and having substantially parallel rows of ribs, wherein one or more magnetic fields are sequentially generated within said frame rib panel in order to impose electromagnetic forces upon said stage rib panel to move said stage with respect to said frame.

2. A photolithography system as recited in claim 1 wherein said stage rib panel is a suitable surface from which heat can dissipate out of said stage rib panel and out of said stage.

3. A photolithography system as recited in claim 2 further comprising:
at least one cooling device suitable for lowering or maintaining the temperature of said frame rib panel such that the temperature of said frame rib panel is approximately less than the temperature of said stage rib panel, whereby heat dissipated from said stage rib panel can be collected into said frame rib panel.

4. A photolithography system as recited in claim 3 wherein said cooling device includes a fluid channel that is in thermal communication with said frame rib panel, wherein coolant fluid flows within said fluid channel.

5. A photolithography system as recited in claim 1 further comprising:
at least one heat-generating device positioned within said stage;
at least one thermal pathway formed between said stage rib panel and each of said heat generating devices wherein each thermal pathway allows heat to travel from a respective heat generating device to said stage rib panel.

6. A photolithography system as recited in claim 5 wherein said heat-generating device is a reticle, a reticle chuck, an integrated circuit device, or a sensor.

7. A photolithography system as recited in claim 6 wherein said integrated circuit device or sensor is positioned approximately adjacent to said stage rib panel, whereby the distance in which heat from said integrated circuit device or sensor travels to said stage rib panel is minimized.

8. A photolithography system as recited in claim 5 wherein said thermal pathway is a thermally conductive material connected to each of said heat-generating device and said stage rib panel.

9. A photolithography system as recited in claim 2 wherein each adjacent rib of said stage rib panel is separated by a recessed channel, said photolithography system further comprising:
a filler material that fills in each of the recessed channels of the stage rib panel such that said stage rib panel has a substantially flat surface formed of said filler material and a top surface of each of said ribs, whereby said flat surface facilitates heat dissipation out of said stage rib panel and said stage.

10. A photolithography system as recited in claim 9 wherein each adjacent rib of said frame rib panel is separated by a recessed channel, said photolithography system further comprising:
a filler material that fills in each of the recessed channels of the frame rib panel such that said frame rib panel has a substantially flat surface formed of said filler material and a top surface of each of said ribs, whereby said flat surface facilitates collection of said heat dissipated out of said stage rib panel and said stage.

11. A photolithography system as recited in claim 1 further comprising:
a transformer that includes an inductive core, a primary inductive coil, and a secondary inductive coil, wherein the inductive core has a first and a second end and wherein the primary inductive coil is wrapped around the first end of the inductive core,
said stage housing the secondary inductive coil,
said frame supporting the inductive core such that the second end of the inductive core extends into the secondary inductive coil, wherein each side surface of the inductive core maintains a minimum distance of separation from an inner surface of the secondary inductive coil, whereby an electrical current within the primary coil creates an electromagnetic field that causes electrical current to flow within the secondary inductive coil; and
wherein said secondary inductive coil is adjacent to said stage rib panel such that heat generated by said secondary inductive coil is collected by said stage rib panel.

12. A photolithography system as recited in claim 1 further comprising:
an Lorentz force electromagnetic motor for adjusting the position of said stage with respect to said frame, said Lorentz force electromagnetic motor including,
a row of opposing magnets within said stage wherein each of the opposing magnets have opposite magnetic polarities, and
a lengthwise coil assembly within said slot of said frame that extends through said stage and between said row of opposing magnets, wherein said coil assembly generates heat that is collected by said stage rib panel.

13. A photolithography system as recited in claim 1 wherein said stage has a top surface and a bottom surface and said slot of said frame has a ceiling surface and a floor surface, and wherein said stage rib panel is attached to said top surface of said stage and said frame rib panel is attached to said ceiling surface of said slot of said frame.

14. A photolithography system as recited in claim 13 further comprising an additional set of stage and frame rib panels wherein said additional stage rib panel is attached to said bottom surface of said stage and said additional frame rib panel is attached to said floor surface of said slot of said frame.

15. A photolithography system comprising:
a stage suitable for supporting a patterned reticle or a semiconductor wafer, said stage having a top surface and a bottom surface;
a frame having an internal slot, said internal slot having a ceiling surface and a floor surface, wherein said stage is contained within said slot;
a variable reluctance electromagnetic motor that includes,
at least two stage rib panels attached to each of said top and bottom surfaces of said stage, said stage rib panels being magnetizable and having parallel rows of ribs that are each separated by a recessed channel, said stage rib panels suitable for collecting heat generated from within said stage;
at least two frame rib panels attached to each of said ceiling and floor surfaces of said frame such that each stage rib panel faces an opposing frame rib panel, said frame rib panels being magnetizable and having parallel rows of ribs that are each separated by a recessed channel, wherein one or more magnetic fields are sequentially generated within said frame rib panel in order to impose electromagnetic forces upon said stage rib panel to accelerate said stage to a desire velocity with respect to said frame along a scanning axis; and
a first Lorentz force electromagnetic motor for adjusting the said velocity of said stage along said scanning axis, said first Lorentz force electromagnetic motor including,
a row of opposing magnet pairs within said stage wherein each magnet of each magnet pairs has an opposite magnetic polarity and wherein a magnetic field is created between each opposing magnet pair, and a lengthwise coil assembly within said slot of said frame that extends through said stage and between said row of opposing magnets, said coil assembly having a plurality of wire coils, wherein a current within each wire coil and each of said magnetic fields generates an electromagnetic force suitable for adjusting the velocity of said stage.

16. A photolithography system as recited in claim 15 further comprising:
a second Lorentz force electromagnetic motor for adjusting the said velocity of said stage along an axis that is orthogonal to said scanning axis, said second Lorentz force electromagnetic motor including,
a row of opposing magnet pairs within said stage wherein each magnet of each magnet pairs has an opposite magnetic polarity and wherein a magnetic field is created between each opposing magnet pair, and
a lengthwise coil assembly within said slot of said frame that extends through said stage and between said row of opposing magnets, said coil assembly having a plurality of wire coils, wherein a current within each wire coil and each of said magnetic fields generates an electromagnetic force suitable for adjusting the velocity of said stage.

17. A photolithography system as recited in claim 15 wherein the parallel rows of ribs in each of the stage and frame rib panels are substantially parallel to each other.

18. A photolithography system as recited in claim 15 wherein each of said stage rib panels are a suitable surface from which heat can dissipate out of said stage rib panels and out of said stage.

19. A photolithography system as recited in claim 18 further comprising:
at least one heat-generating device positioned within said stage;
at least one thermal pathway formed between each of said stage rib panels and each of said heat generating devices wherein each thermal pathway allows heat to travel from a respective heat generating device to said stage rib panels.

20. A photolithography system as recited in claim 19 wherein said heat-generating device is a reticle, a reticle chuck, an integrated circuit device, or a sensor.

21. A photolithography system as recited in claim 20 wherein said integrated circuit device or sensor is positioned approximately adjacent to one of said stage rib panels, whereby the distance in which heat from said integrated circuit device or sensor travels to said stage rib panel is minimized.

22. A photolithography system as recited in claim 18 further comprising:
at least one cooling device suitable for lowering or maintaining the temperature of said frame rib panel such that the temperature of said frame rib panel is approximately less than the temperature of said stage rib panel, whereby heat dissipated from said stage rib panel can be collected into said frame rib panel.

23. A photolithography system as recited in claim 18 further comprising a filler material that fills in each of the recessed channels of each of said stage rib panels such that said stage rib panels have a substantially flat surface formed of said filler material and a top surface of each of said ribs, whereby said flat surface facilitates heat dissipation out of said stage rib panels and said stage.

24. A photolithography system as recited in claim 23 further comprising a filler material that fills in each of the recessed channels of said frame rib panels such that said frame rib panels have a substantially flat surface formed of said filler material and a top surface of each of said ribs, whereby said flat surface facilitates collection of said heat dissipated out of said stage rib panels and said stage.

25. A photolithography system as recited in claim 18 further comprising:
a transformer that includes an inductive core, a primary inductive coil, and a secondary inductive coil, wherein the inductive core has a first and a second end and wherein the primary inductive coil is wrapped around the first end of the inductive core,
said stage housing the secondary inductive coil,
said frame supporting the inductive core such that the second end of the inductive core extends into the secondary inductive coil, wherein each side surface of the inductive core maintains a minimum distance of separation from an inner surface of the secondary inductive coil, whereby an electrical current within the primary coil creates an electromagnetic field that causes electrical current to flow within the secondary inductive coil; and
wherein said secondary inductive coil is adjacent to at least one of said stage rib panels such that heat generated by said secondary inductive coil is collected by said stage rib panels.

26. A photolithography system comprising:
an illumination source;
an optical system;
a reticle stage suitable for supporting a patterned reticle;
a working stage arranged to retain a workpiece;
an enclosure that surrounds at least a portion of the working stage, the enclosure having a sealing surface;
a stage rib panel attached to a surface of said stage, said stage rib panel being magnetizable and having parallel rows of ribs that are each separated by a recessed channel, said stage rib panel suitable for collecting heat generated from within said stage;
a frame having an internal slot wherein said stage is contained within said slot; and
a frame rib panel attached to a surface of said frame such that the stage rib panel and the frame rib panel face each other, said frame rib panel being magnetizable and having parallel rows of ribs that are each separated by a recessed channel, wherein one or more magnetic fields are sequentially generated within said frame rib panel in order to impose electromagnetic forces upon said stage rib panel to move said stage with respect to said frame.

27. An object manufactured with the photolithography system of claim 26.

28. A wafer on which an image has been formed by the photolithography system of claim 26.

29. A method for making an object using a photolithography process, wherein the photolithography process utilizes a photolithography system as recited in claim 26.

30. A method for patterning a wafer using a photolithography process, wherein the photolithography process utilizes a photolithography system as recited in claim 26.
